(19) United States
(12) Patent Application Publication
(10) Pub. No.: US 2024/0106828 A1
(43) Pub. Date: Mar. 28, 2024

(54) SYSTEM AND METHOD FOR IMPLEMENTING A CLOUD AGNOSTIC DATA MESH MODULE

(71) Applicant: JPMorgan Chase Bank, N.A., New York, NY (US)

(72) Inventors: Anu JAIN, Westfield, NJ (US); Ravi NAGVEKAR, Metuchen, NJ (US); Anne MCCLURE, Chapel Hill, NC (US); Sovon NATH, Glen Allen, VA (US); Brian BONOMO, Oak Park, IL (US); Matthew P AGOSTINELLI, Plano, TX (US); Ram GUTTA, Newark, DE (US)

(73) Assignee: JPMorgan Chase Bank, N.A., New York, NY (US)

(21) Appl. No.: 18/374,169

(22) Filed: Sep. 28, 2023

Related U.S. Application Data
(60) Provisional application No. 63/410,792, filed on Sep. 28, 2022.

(51) Int. Cl. H04L 9/40; H04L 67/1001; H04L 67/12

(52) U.S. Cl. CPC H04L 63/10; H04L 67/1001; H04L 67/12

(57) ABSTRACT

Various methods, apparatuses/systems, and media for providing centralized seamless data access are disclosed. A processor builds a data mesh architecture in a cloud environment. The data mesh architecture includes a single central hub account provided between a plurality of data producer accounts and a plurality of data consumer accounts. The processor causes the plurality of data producer accounts to publish different types of data received from a plurality of data sources onto the single central hub account along with corresponding metadata. The processor also causes the single central hub account to: incorporate the metadata into an application; receive a request from the plurality of data consumer accounts to access the published different types of data from the single central hub account; and control who from the plurality of data consumer accounts can access the published different types of data from the single central hub account based on the metadata.

### CROSS-REFERENCE TO RELATED APPLICATIONS

This application claims the benefit of priority from U.S. Provisional Patent Application No. 63/410,792, filed Sep. 28, 2022, which is herein incorporated by reference in its entirety.

### TECHNICAL FIELD

This disclosure generally relates to data processing, and, more particularly, to methods and apparatuses for implementing a cloud agnostic data mesh module for providing scalable implementation and centralized seamless data access to data consumers/analyst and applications.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Today, a wide variety of business functions are commonly supported by software applications and tools, i.e., business intelligence (BI) tools. For instance, software has been directed to performance analysis, project tracking, and competitive analysis, to name but a few. In general, large enterprises, corporations, agencies, institutions, and other organizations are facing a continuing problem of handling, processing, and/or accurately describing a vast amount of data (often exceeding 450 petabytes) that are crucial to plan actions at store level or market/regional level in an efficient and expedited manner. The stored data is often not in a centralized location, yet needs to be analyzed by a variety of persons within the organization to inform strategy, which may prove to be extremely time consuming, confusing, inaccurate, and inefficient for planning actions at both store level and market/regional level. Conventional tools fail to adequately address, among others, issues related to data duplication, data aging, data not discoverable, data quality, etc., resulting in failing to enable a faster time to market for data consumption in the public cloud and thereby significantly reducing the quality of connected and personalized customer experiences, and increasing risks of system failures.

### SUMMARY

The present disclosure, through one or more of its various aspects, embodiments, and/or specific features or sub-components, provides, among other features, various systems, servers, devices, methods, media, programs, and platforms for implementing a cloud agnostic data mesh module for providing scalable implementation and centralized seamless data access to data consumers/analyst and application, but the disclosure is not limited thereto. For example, the present disclosure, through one or more of its various aspects, embodiments, and/or specific features or sub-components, also provides, among other features, various systems, servers, devices, methods, media, programs, and platforms for implementing the cloud agnostic data mesh module to establish a data mesh in a public cloud that enables accelerated access to trusted and secure business value product data sets that are aligned to high priority strategic use cases from consumers; leverage the design of a data mesh in the public cloud enabling data to be free from the duplication and processing complexities that currently bind and constrain its use in today's systems, but the disclosure is not limited thereto. According to an aspect of the present disclosure, the foundation of the data mesh may include establishing the design of the access controls and intercommunication boundaries between producers, consumers, and a central hub, but the disclosure is not limited thereto.

According to an aspect of the present disclosure, a method for automatically providing centralized seamless data access to data consumers/analyst and applications by utilizing one or more processors along with allocated memory is disclosed. The method may include: building a data mesh architecture in a cloud environment, wherein the data mesh architecture includes a plurality of data producer accounts, a single central hub account, and a plurality of data consumer accounts; calling, by the plurality of data producer accounts, corresponding application programming interface to access different types of data from a plurality of data sources; describing, in response to calling the application programming interface, what each type of data is with a corresponding tag, wherein each tag is a metadata associated with each type of data describing what that data is; publishing, by the plurality of data producer accounts, the different types of data received from the plurality of data sources onto the single central hub account along with the corresponding metadata; incorporating the metadata into an application within the single central hub account; receiving a request, from the plurality of data consumer accounts, to access the published different types of data from the single central hub account; and controlling, by the single central hub account, in response to receiving the request, who from the plurality of data consumer accounts can access the published different types of data from the single central hub account based on the metadata.

According to a further aspect of the present disclosure, each data producer account of the plurality of data producer accounts may be configured to manage procurement, transformation, and presentation of data and delegate responsibility for controlling access to their data to the single central hub account.

According to another aspect of the present disclosure, the single central hub account may be configured to connect the plurality of data producer accounts and the plurality of data consumer accounts in a manner such that the data consumer accounts can only access data of the data producer accounts via the single central hub account.

According to yet another aspect of the present disclosure, each data consumer account among the plurality of data consumer accounts may be configured to enable analytic environments in which end users can access data exposed by the data producer accounts through the single central hub account.

According to an aspect of the present disclosure, the method may further include: implementing the data mesh architecture in a manner such that data is not duplicated outside of the data producer accounts.

According to a further aspect of the present disclosure, in the data mesh architecture, each type of data may be treated and enabled as data product and the plurality of data sources are product owners of corresponding data product in the data mesh architecture.

According to another aspect of the present disclosure, the different types of data may include data received from system of records that owns system of record data products; data received from utility data sources that won utility data products; data received from product data sets; and data received from third party data sets, but the disclosure is not limited thereto.

According to an aspect of the present disclosure, a system for automatically providing centralized seamless data access to data consumers/analyst and applications is disclosed. The system may include a processor; and a memory operatively connected to the processor via a communication interface, the memory storing computer readable instructions, when executed, may cause the processor to: build a data mesh architecture in a cloud environment, wherein the data mesh architecture includes a plurality of data producer accounts, a single central hub account, and a plurality of data consumer accounts; call, by the plurality of data producer accounts, corresponding application programming interface to access different types of data from a plurality of data sources; describe, by the plurality of data producer accounts, in response to calling the application programming interface, what each type of data is with a corresponding tag, wherein each tag is a metadata associated with each type of data describing what that data is; publish, by the plurality of data producer accounts, the different types of data received from the plurality of data sources onto the single central hub account along with the corresponding metadata; incorporate the metadata into an application within the single central hub account; receive a request, from the plurality of data consumer accounts, to access the published different types of data from the single central hub account; and control, by the single central hub account, in response to receiving the request, who from the plurality of data consumer accounts can access the published different types of data from the single central hub account based on the metadata.

According to a further aspect of the present disclosure corresponding to the system, each data producer account of the plurality of data producer accounts may be configured to manage procurement, transformation, and presentation of data and delegate responsibility for controlling access to their data to the single central hub account.

According to another aspect of the present disclosure corresponding to the system, the single central hub account may be configured to connect the plurality of data producer accounts and the plurality of data consumer accounts in a manner such that the data consumer accounts can only access data of the data producer accounts via the single central hub account.

According to yet another aspect of the present disclosure corresponding to the system, each data consumer account among the plurality of data consumer accounts may be configured to enable analytic environments in which end users can access data exposed by the data producer accounts through the single central hub account.

According to an aspect of the present disclosure corresponding to the system, the processor may be further configured to implement the data mesh architecture in a manner such that data is not duplicated outside of the data producer accounts.

According to a further aspect of the present disclosure corresponding to the system, in the data mesh architecture, each type of data may be treated and enabled as data product and the plurality of data sources are product owners of corresponding data product in the data mesh architecture.

According to another aspect of the present disclosure corresponding to the system, the different types of data may include data received from system of records that owns system of record data products; data received from utility data sources that won utility data products; data received from product data sets; and data received from third party data sets, but the disclosure is not limited thereto.

According to yet another aspect of the present disclosure, a non-transitory computer readable medium configured to store instructions for automatically providing centralized seamless data access to data consumers/analyst and application is disclosed. The instructions, when executed, may cause a processor to perform the following: building a data mesh architecture in a cloud environment, wherein the data mesh architecture includes a plurality of data producer accounts, a single central hub account, and a plurality of data consumer accounts; calling, by the plurality of data producer accounts, corresponding application programming interface to access different types of data from a plurality of data sources; describing, in response to calling the application programming interface, what each type of data is with a corresponding tag, wherein each tag is a metadata associated with each type of data describing what that data is; publishing, by the plurality of data producer accounts, the different types of data received from the plurality of data sources onto the single central hub account along with the corresponding metadata; incorporating the metadata into an application within the single central hub account; receiving a request, from the plurality of data consumer accounts, to access the published different types of data from the single central hub account; and controlling, by the single central hub account, in response to receiving the request, who from the plurality of data consumer accounts can access the published different types of data from the single central hub account based on the metadata.

According to a further aspect of the present disclosure corresponding to the non-transitory computer readable medium, each data producer account of the plurality of data producer accounts may be configured to manage procurement, transformation, and presentation of data and delegate responsibility for controlling access to their data to the single central hub account.

According to another aspect of the present disclosure corresponding to the non-transitory computer readable medium, the single central hub account may be configured to connect the plurality of data producer accounts and the plurality of data consumer accounts in a manner such that the data consumer accounts can only access data of the data producer accounts via the single central hub account.

According to yet another aspect of the present disclosure corresponding to the non-transitory computer readable medium, each data consumer account among the plurality of data consumer accounts may be configured to enable analytic environments in which end users can access data exposed by the data producer accounts through the single central hub account.

According to an aspect of the present disclosure corresponding to the non-transitory computer readable medium, the instructions, when executed, may further cause the processor to perform the following: implementing the data mesh architecture in a manner such that data is not duplicated outside of the data producer accounts.

According to a further aspect of the present disclosure corresponding to the non-transitory computer readable medium, in the data mesh architecture, each type of data may be treated and enabled as data product and the plurality of data sources are product owners of corresponding data product in the data mesh architecture.

According to another aspect of the present disclosure corresponding to the non-transitory computer readable medium, the different types of data may include data received from non-transitory computer readable medium of records that owns non-transitory computer readable medium of record data products; data received from utility data sources that won utility data products; data received from product data sets; and data received from third party data sets, but the disclosure is not limited thereto.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a cloud agnostic data mesh module that may be configured for scalable implementation and providing automatic centralized seamless data access to data consumers/analyst and applications in accordance with an exemplary embodiment.

FIG. 2 illustrates an exemplary diagram of a network environment with a cloud agnostic data mesh device in accordance with an exemplary embodiment.

FIG. 3 illustrates a system diagram for implementing a cloud agnostic data mesh device having a cloud agnostic data mesh module in accordance with an exemplary embodiment.

FIG. 4 illustrates a system diagram for implementing a cloud agnostic data mesh module of FIG. 3 in accordance with an exemplary embodiment.

FIG. 5 illustrates an exemplary data mesh architecture diagram implemented by the cloud agnostic data mesh module of FIG. 4 in accordance with an exemplary embodiment.

FIG. 6 illustrates an exemplary data ingestion workflow implemented by the cloud agnostic data mesh module of FIG. 4 in accordance with an exemplary embodiment.

FIG. 7 illustrates an exemplary data processing workflow in the producer account implemented by the cloud agnostic data mesh module of FIG. 4 in accordance with an exemplary embodiment.

FIG. 8 illustrates an exemplary architecture of a central hub account implemented by the cloud agnostic data mesh module of FIG. 4 in which the central hub account is a single account to which data producer accounts directly connect in accordance with an exemplary embodiment.

FIG. 9 illustrates an exemplary architecture implemented by the cloud agnostic data mesh module of FIG. 4 in which identity and access management (IAM) roles are created and granted lake formation permissions based on a user's cost center alignment in accordance with an exemplary embodiment.

FIG. 10 illustrates another exemplary architecture implemented by the cloud agnostic data mesh module of FIG. 4 in which users that have access to multiple roles can only assume one role at a time in accordance with an exemplary embodiment.

FIG. 11 illustrates another exemplary architecture implemented by the cloud agnostic data mesh module of FIG. 4 in which cross account data lake location registration is illustrated in accordance with an exemplary embodiment.

FIG. 12 illustrates an exemplary database requester workflow between accounts with glue data catalog tagging implemented by the cloud agnostic data mesh module of FIG. 4 in accordance with an exemplary embodiment.

FIG. 13 illustrates an exemplary flow chart implemented by the cloud agnostic data mesh module of FIG. 4 for scalable implementation and automatic centralized seamless data access to data consumers/analyst and applications in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

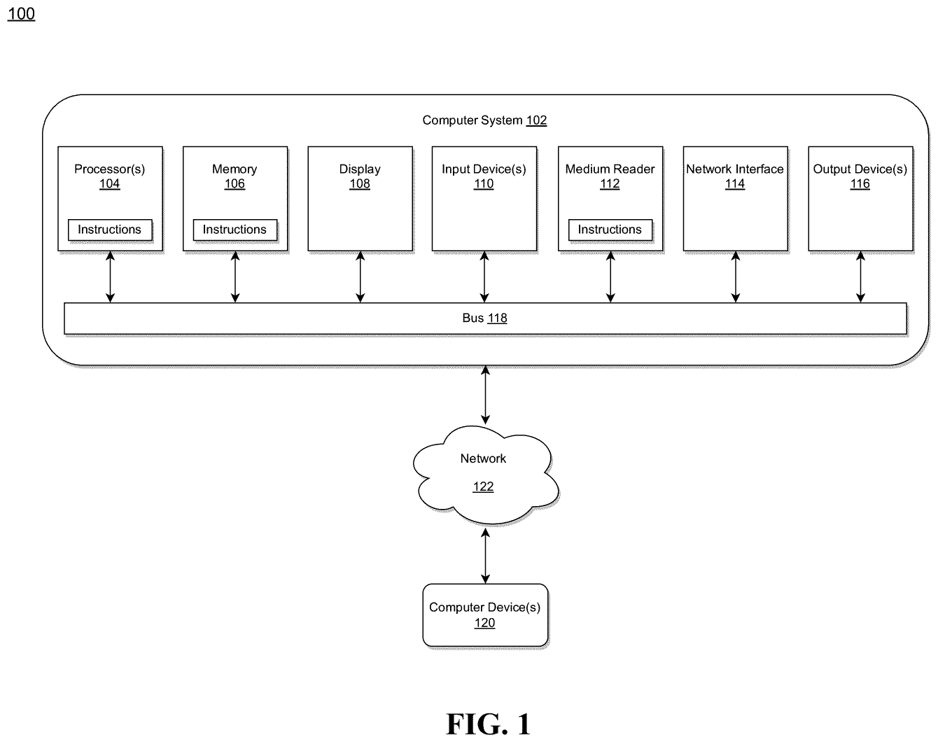

FIG. 1 is an exemplary system 100 for use in implementing a cloud agnostic data mesh module that may be configured for scalable implementation and providing automatic centralized seamless data access to data consumers/analyst and applications in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the data mesh module may be cloud agnostic that may allow for consistent easy orchestration and passing of data through various components to output a desired result regardless of cloud environment. Since the disclosed process, according to exemplary embodiments, is cloud agnostic, the data mesh module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

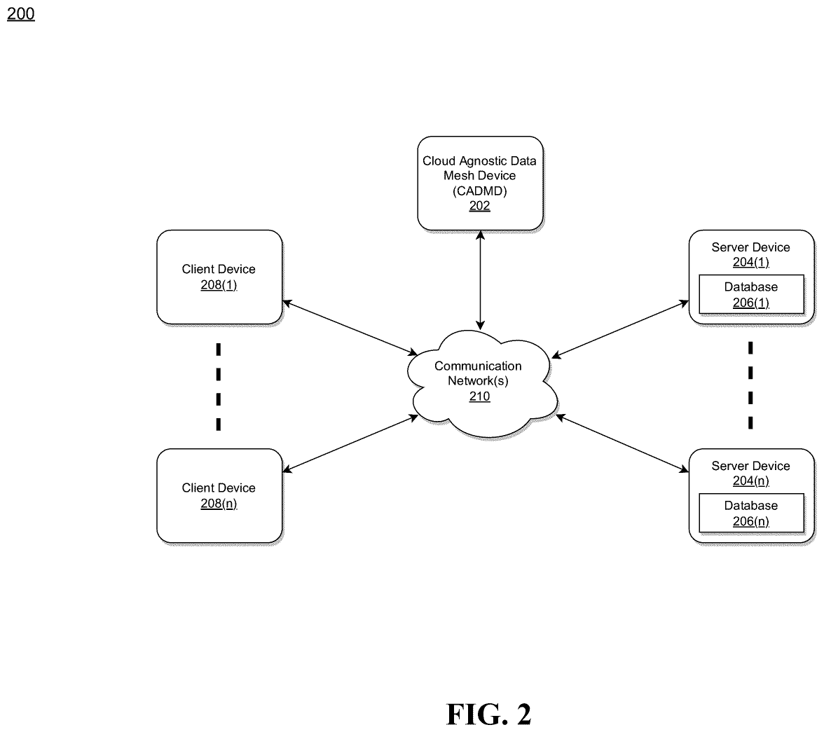

Referring to FIG. 2, a schematic of an exemplary network environment 200 for implementing a cloud agnostic data mesh device (CADMD) of the instant disclosure is illustrated.

According to exemplary embodiments, the above-described problems associated with conventional tools may be overcome by implementing a CADMD 202 as illustrated in FIG. 2 that may be configured for implementing a cloud agnostic data mesh module for providing scalable implementation and automated centralized seamless data access to data consumers/analyst and application, but the disclosure is not limited thereto. For example, according to exemplary embodiments, the above-described problems associated with conventional tools may be overcome by implementing a CADMD 202 as illustrated in FIG. 2 that may be configured for implementing a cloud agnostic data mesh module to establish a data mesh in a public cloud that enables accelerated access to trusted and secure business value product data sets that are aligned to high priority strategic use cases from consumers; leverage the design of a data mesh in the public cloud enabling data to be free from the duplication and processing complexities that currently bind and constrain its use in today's systems, but the disclosure is not limited thereto. According to an aspect of the present disclosure, the foundation of the data mesh may include establishing the design of the access controls and intercommunication boundaries between producers, consumers, and a central hub, but the disclosure is not limited thereto.

The CADMD 202 may be the same or similar to the computer system 102 as described with respect to FIG. 1.

The CADMD 202 may store one or more applications that can include executable instructions that, when executed by the CADMD 202, cause the CADMD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CADMD 202 itself, may be located in virtual server(s) running in a cloud-based computing environment rather than being tied to one or more specific physical network computing devices. Also, the application(s) may be running in one or more virtual machines (VMs) executing on the CADMD 202. Additionally, in one or more embodiments of this technology, virtual machine(s) running on the CADMD 202 may be managed or supervised by a hypervisor.

In the network environment 200 of FIG. 2, the CADMD 202 is coupled to a plurality of server devices 204(1)-204(n) that hosts a plurality of databases 206(1)-206(n), and also to a plurality of client devices 208(1)-208(n) via communication network(s) 210. A communication interface of the CADMD 202, such as the network interface 114 of the computer system 102 of FIG. 1, operatively couples and communicates between the CADMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CADMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CADMD 202 may be a standalone device or integrated with one or more other devices or apparatuses, such as one or more of the server devices 204(1)-204(n), for example. In one particular example, the CADMD 202 may be hosted by one of the server devices 204(1)-204(n), and other arrangements are also possible. Moreover, one or more of the devices of the CADMD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CADMD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the CADMD 202 that may efficiently provide a platform for implementing a cloud agnostic data mesh module for providing scalable implementation and automated centralized seamless data access to data consumers/analyst and application, but the disclosure is not limited thereto. For example, according to exemplary embodiments, the client devices 208(1)-208(n) in this example may include any type of computing device that can facilitate the implementation of the CADMD 202 that may efficiently provide a platform for implementing a cloud agnostic data mesh module to establish a data mesh in a public cloud that enables accelerated access to trusted and secure business value product data sets that are aligned to high priority strategic use cases from consumers; leverage the design of a data mesh in the public cloud enabling data to be free from the duplication and processing complexities that currently bind and constrain its use in today's systems, but the disclosure is not limited thereto.

The client devices 208(1)-208(n) may run interface applications, such as standard web browsers or standalone client applications, which may provide an interface to communicate with the CADMD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the CADMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the CADMD 202, the server devices 204(1)-204(n), or the client devices 208(1)-208(n), for example, may be configured to operate as virtual instances on the same physical machine. For example, one or more of the CADMD 202, the server devices 204(1)-204(n), or the client devices 208(1)-208(n) may operate on the same physical device rather than as separate devices communicating through communication network(s) 210. Additionally, there may be more or fewer CADMDs 202, server devices 204(1)-204(n), or client devices 208(1)-208(n) than illustrated in FIG. 2. According to exemplary embodiments, the CADMD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

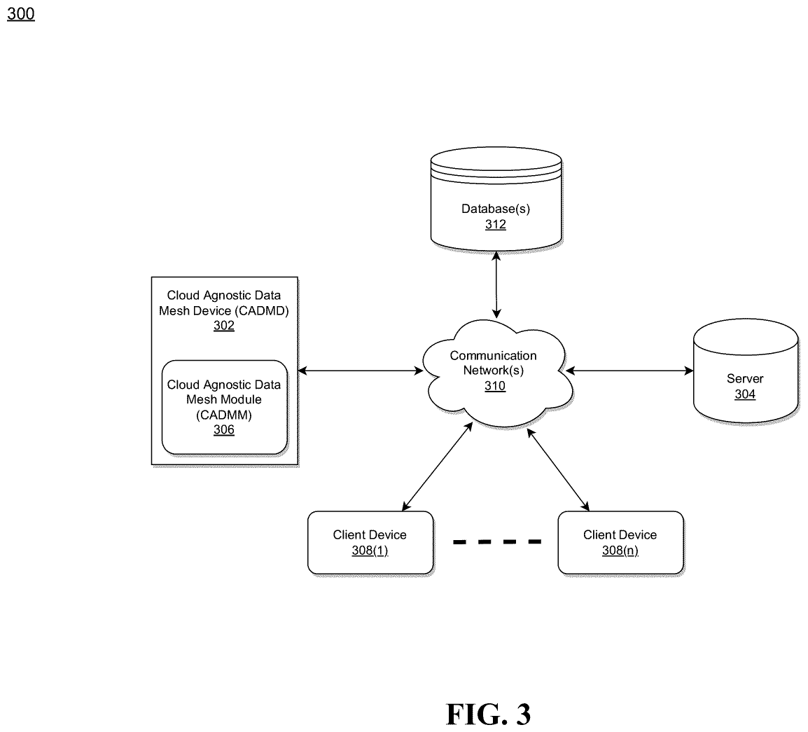

FIG. 3 illustrates a system diagram for implementing a CADMD having a cloud agnostic data mesh module (CADMM) in accordance with an exemplary embodiment.

As illustrated in FIG. 3, the system 300 may include a CADMD 302 within which an CADMM 306 is embedded, a server 304, a database(s) 312, a plurality of client devices 308(1) . . . 308(n), and a communication network 310.

According to exemplary embodiments, the CADMD 302 including the CADMM 306 may be connected to the server 304, and the database(s) 312 via the communication network 310. The CADMD 302 may also be connected to the plurality of client devices 308(1) . . . 308(n) via the communication network 310, but the disclosure is not limited thereto.

According to exemplary embodiment, the CADMD 302 is described and shown in FIG. 3 as including the CADMM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the CADMM 306 may be configured to receive real-time feed of data from the plurality of client devices 308(1) . . . 308(n) via the communication network 310.

As may be described below, the CADMM 306 may be configured to: build a data mesh architecture in a cloud environment, wherein the data mesh architecture includes a plurality of data producer accounts, a single central hub account, and a plurality of data consumer accounts; call, by the plurality of data producer accounts, corresponding application programming interface to access different types of data from a plurality of data sources; describe, by the plurality of data producer accounts, in response to calling the application programming interface, what each type of data is with a corresponding tag, wherein each tag is a metadata associated with each type of data describing what that data is; publish, by the plurality of data producer accounts, the different types of data received from the plurality of data sources onto the single central hub account along with the corresponding metadata; incorporate the metadata into an application within the single central hub; receive a request, from the plurality of data consumer accounts, to access the published different types of data from the single central hub account; and control, by the single central hub account, in response to receiving the request, who from the plurality of data consumer accounts can access the published different types of data from the single central hub account based on the metadata, but the disclosure is not limited thereto.

The plurality of client devices 308(1) . . . 308(n) are illustrated as being in communication with the CADMD 302. In this regard, the plurality of client devices 308(1) . . . 308(n) may be “clients” (e.g., customers) of the CADMD 302 and are described herein as such. Nevertheless, it is to be known and understood that the plurality of client devices 308(1) . . . 308(n) need not necessarily be “clients” of the CADMD 302, or any entity described in association therewith herein. Any additional or alternative relationship may exist between either or both of the plurality of client devices 308(1) . . . 308(n) and the CADMD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the CADMD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The CADMD 302 may be the same or similar to the CADMD 202 as described with respect to FIG. 2, including any features or combination of features described with respect thereto.

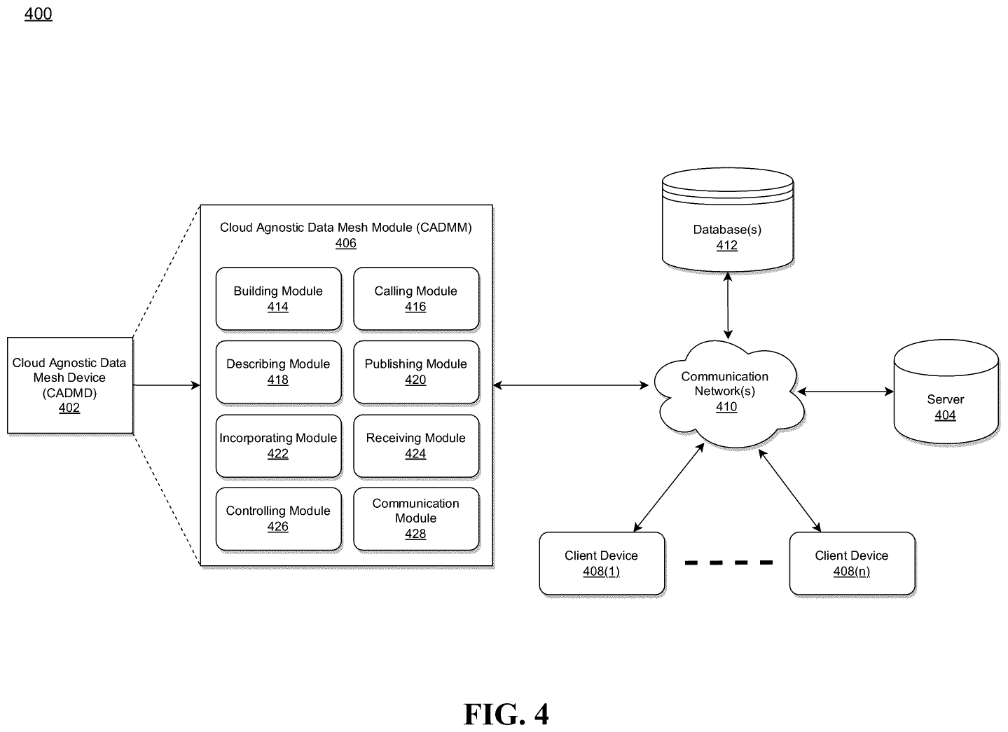

FIG. 4 illustrates a system diagram for implementing a CADMM of FIG.3 in accordance with an exemplary embodiment.

According to exemplary embodiments, the system 400 may include a cloud agnostic CADMD 402 within which a cloud agnostic CADMM 406 is embedded, a server 404, database(s) 412, and a communication network 410.

According to exemplary embodiments, the CADMD 402 including the CADMM 406 may be connected to the server 404 and the database(s) 412 via the communication network 410. The CADMD 402 may also be connected to the plurality of client devices 408(1)-408(n) via the communication network 410, but the disclosure is not limited thereto. The CADMM 406, the server 404, the plurality of client devices 408(1)-408(n), the database(s) 412, the communication network 410 as illustrated in FIG. 4 may be the same or similar to the CADMM 306, the server 304, the plurality of client devices 308(1)-308(n), the database(s) 312, the communication network 310, respectively, as illustrated in FIG. 3.

According to exemplary embodiments, as illustrated in FIG. 4, the CADMM 406 may include a building module 414, a calling module 416, a describing module 418, a publishing module 420, an incorporating module 422, a receiving module 424, a controlling module 426, and a communication module 428. According to exemplary embodiments, interactions and data exchange among these modules included in the CADMM 406 provide the advantageous effects of the disclosed invention. Functionalities of each module of FIG. 4 may be described in detail below with reference to FIGS. 4-12.

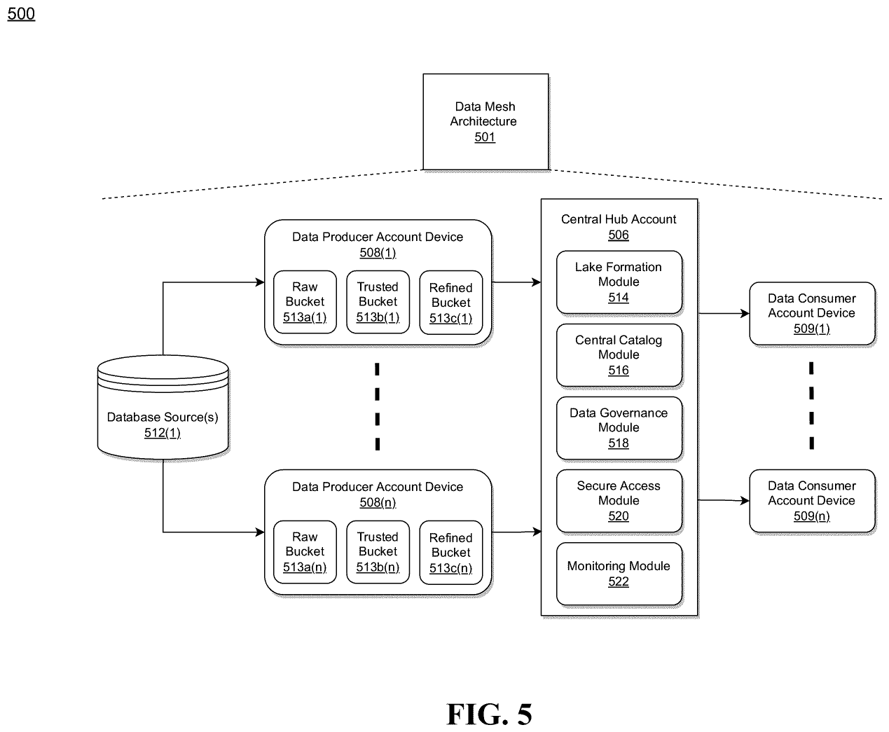

According to exemplary embodiments, FIG. 5 illustrates an exemplary data mesh architecture diagram 500 implemented by the CADMM 406 of FIG. 4 in accordance with an exemplary embodiment. As illustrated in FIG. 5, the exemplary data mesh architecture diagram 500 includes a data mesh architecture 501. The data mesh architecture 501 may include a plurality of database sources 512(1) that are connected to a plurality of data producer account devices 508(1)-508(n); a central hub account 506 provided between the plurality of data producer devices 508(1)-508(n) and a plurality of data consumer account devices 509(1)-509(n). The central hub account 506 may include a lake formation module 514, a central catalog module 514, a data governance module 518, a secure access module 520, and a monitoring module 522. According to exemplary embodiments, interactions and data exchange among these modules included in the central hub account 506 provide the advantageous effects of the disclosed invention. Functionalities of each module of FIG. 5 may be described in detail below with reference to FIGS. 5-12.

Referring to FIGS. 4 and 5, according to exemplary embodiments, each of the building module 414, calling module 416, describing module 418, publishing module 420, incorporating module 422, receiving module 424, controlling module 426, and the communication module 428 of the CADMM 406 of FIG. 4 and each of the lake formation module 514, central catalog module 514, data governance module 518, secure access module 520, and the monitoring module 522 of the central hub account 506 of FIG. 5 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the building module 414, calling module 416, describing module 418, publishing module 420, incorporating module 422, receiving module 424, controlling module 426, and the communication module 428 of the CADMM 406 of FIG. 4 and each of the lake formation module 514, central catalog module 514, data governance module 518, secure access module 520, and the monitoring module 522 of the central hub account 506 of FIG. 5 may be implemented by microprocessors or similar, and may be programmed using software (e.g., microcode) to perform various functions discussed herein and may optionally be driven by firmware and/or software.

Alternatively, according to exemplary embodiments, each of the building module 414, calling module 416, describing module 418, publishing module 420, incorporating module 422, receiving module 424, controlling module 426, and the communication module 428 of the CADMM 406 of FIG. 4 and each of the lake formation module 514, central catalog module 514, data governance module 518, secure access module 520, and the monitoring module 522 of the central hub account 506 of FIG. 5 may be implemented by dedicated hardware, or as a combination of dedicated hardware to perform some functions and a processor (e.g., one or more programmed microprocessors and associated circuitry) to perform other functions.

According to exemplary embodiments, each of the building module 414, calling module 416, describing module 418, publishing module 420, incorporating module 422, receiving module 424, controlling module 426, and the communication module 428 of the CADMM 406 of FIG. 4 and each of the lake formation module 514, central catalog module 514, data governance module 518, secure access module 520, and the monitoring module 522 of the central hub account 506 of FIG. 5 may be called via corresponding API.

Referring to FIG. 4, the process may be executed via the communication module 428 and the communication network 410, which may comprise plural networks as described above. For example, in an exemplary embodiment, the various components of the CADMM 406 may communicate with the server 404, and the database(s) 412 via the communication module 428 and the communication network 410. Of course, these embodiments are merely exemplary and are not limiting or exhaustive.

Referring to FIGS. 4-5, according to exemplary embodiments, the building module 414 may be configured to build a data mesh architecture 501 in a cloud environment (i.e., a public cloud), wherein the data mesh architecture 501 may include a plurality of data producer accounts (i.e., included in the data producer account devices 508(1)-508(n)), a single central hub account 506, and a plurality of data consumer accounts (i.e., included in the data consumer account devices 509(1)-509(n)). The calling module 416 may be configured to call, by utilizing the plurality of data producer accounts, corresponding application programming interface to access different types of data from the plurality of data sources (i.e., database sources 512(1)). The describing module 418 may be configured to describing, in response to calling the application programming interface, what each type of data is with a corresponding tag, wherein each tag is a metadata associated with each type of data describing what that data is.

According to exemplary embodiments, the publishing module 420 may be configured to publish, by utilizing the plurality of data producer accounts, the different types of data received from the plurality of data sources (i.e., database sources 512(1)) onto the single central hub account 506 along with the corresponding metadata. The incorporating module 422 may be configured to incorporate the metadata into an application (not shown) within the single central hub account 506.

According to exemplary embodiments, the receiving module 424 may be configured to receive a request, from the plurality of data consumer accounts (i.e., included in the data consumer account devices 509(1)-509(n)), to access the published different types of data from the single central hub account 506. The controlling module 426 may be configured to control, by utilizing the single central hub account 506, in response to receiving the request, who from the plurality of data consumer accounts can access the published different types of data from the single central hub account 506 based on the metadata.

According to exemplary embodiments, the incorporating module 422 may be configured to implement the data mesh architecture 501 in a manner such that data is not duplicated outside of the data producer accounts.

According to exemplary embodiments, in the data mesh architecture 501, each type of data may be treated and enabled as data product and the plurality of data sources are product owners of corresponding data product in the data mesh architecture 501. As product owners, they aim to deliver high-quality data products that meet the needs of data consumers who utilize the data consumer account devices 509(1)-509(n). Data consumers shop for data products that meet their needs, make requests for new products, and give feedback to data producers about their products. According to exemplary embodiments, the data mesh architecture 501 serves to enforce strong governance by providing a consumer driven data marketplace where the interaction between data producers, data products, and data consumers is easily and tightly controlled.

According to an exemplary embodiment, the data mesh architecture 501 may be implemented in the AWS public cloud and can leverage native services for building scalable and performant data lakes using Amazon S3, AWS Lake Formation, AWS Glue, and AWS Athena, etc., but the disclosure is not limited to this public cloud. The data mesh architecture 501 may be implemented any other public cloud or private cloud without departing from the scope of the present disclosure.

According to exemplary embodiments, the different types of data may include data received from system of records that owns system of record data products; data received from utility data sources that won utility data products; data received from product data sets; and data received from third party data sets, but the disclosure is not limited thereto.

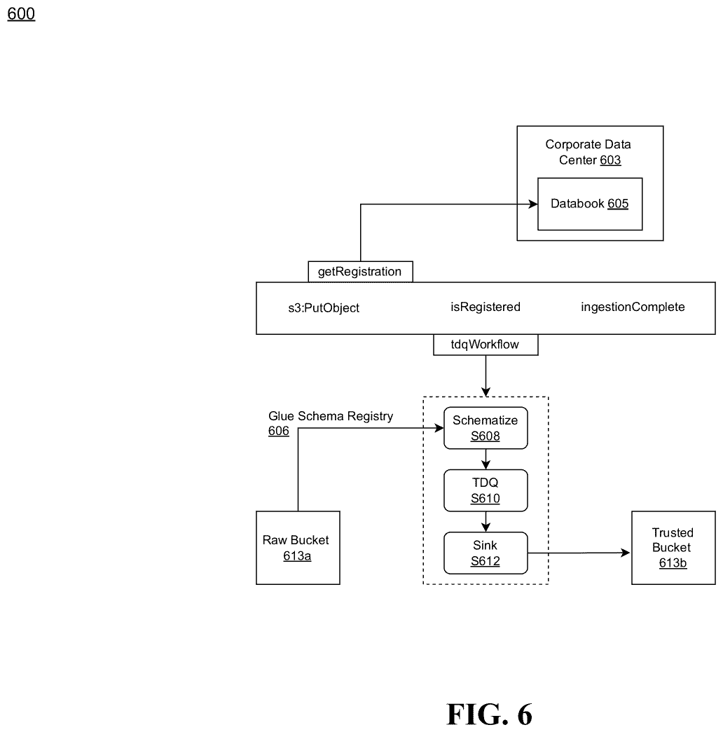

As illustrated in FIG. 5, the data mesh architecture 501 utilizes a central governance hub connected to multiple data producer accounts and multiple data consumer accounts. For example, these accounts may be based on a plurality of sub line of businesses (sub LOBs). The logic behind this design is described further with reference to FIGS. 6-12.

According to exemplary embodiments, each data producer account of the plurality of producer accounts may be configured to manage procurement, transformation, and presentation of data and delegate responsibility for controlling access to their data to the single central hub account.

According to exemplary embodiments, the single central hub account may be configured to connect the plurality of data producer accounts and the plurality of data consumer accounts in a manner such that the data consumer accounts can only access data of the data producer accounts via the single central hub account 506.

According to exemplary embodiments, each data consumer account among the plurality of data consumer accounts may be configured to enable analytic environments in which end users can access data exposed by the data producer accounts through the single central hub account 506.

For ease of description purposes only, according to an exemplary use case scenario, it is assumed that there are thirteen sub LOBs for the producer accounts and thirteen sub LOBs for the consumer accounts. For one producer account per sub-LOB is recommended for the producer account structure as it will easily scale with the dynamics of business demand Tus, there may be thirteen producer accounts in the data mesh architecture 501 that align directly with the thirteen sub-LOBs which in turn corresponds to each sub-LOB's data products.

According to exemplary embodiments, there may be three types of data products: System of Record (SOR) Business Products; Utility Products; and Cross-domain curated Product Data Sets for Analytics. Within a given sub-LOB, the data that comprises their SOR Business Products and their Utility Products is distinct to their sub-LOB and does not contain data from other sub-LOBs. When data products are needed that contain data from multiple sub-LOBs, this is considered a cross-domain curated product data set, and will exist in the Data and Analytics sub-LOB data Producer Account.

According to this exemplary use case, the account structure for the data mesh architecture 501 may contain twenty seven (27) accounts, i.e., the single central hub account, the thirteen sub-LOB producer accounts, and their thirteen corresponding sub-LOB consumer accounts.

According to exemplary embodiments, the data mesh architecture 501 relies on each of the 27 accounts to use the AWS Lake Formation managed service. AWS Lake Formation eases the complexity of managing data lakes. It leverages existing AWS services such as Amazon S3 and AWS Glue as well as capabilities for fine grained access control and row level filtering. A single AWS Glue Data Catalog in the central hub account 506 owns all catalog resources in the data mesh architecture 501. The thirteen producer accounts and their corresponding thirteen consumer accounts reference this central catalog through the use of AWS Resource Links, which are symbolic links from the AWS Glue Data Catalog in their specific producer or consumer account to the AWS Glue Data Catalog in the central hub account 506.

A key feature of the data mesh architecture 501, according to exemplary embodiments, is that data is not duplicated outside of the producer account. All data catalog resources in the central hub account 506 point to data stored in producer account's S3 buckets. The central hub account 506 is responsible for tag based access control and for granting permissions to producers and consumers.

According to exemplary embodiments, data from multiple SEALs and multiple SORs may be ingested and managed within the same producer account, creating a multi-tenant environment within the account. These different tenants will store data in the same three buckets (i.e., raw bucket 513a(1)-513a(n), trusted bucket 513b(1)-513b(n), and refined bucket 513c(1)-513c(n)) within the producer account. Each bucket serves a specific purpose and has an associated pathing convention that is purposefully designed to enable multi-tenancy.

The raw bucket 513a(1)-513a(n) is the initial landing location for data being ingested into a producer account. Data objects that land in the raw bucket 513a(1)-513a(n) are only accessible to the role that is executing data ingestion automation. The primary purpose of restricting access to the raw bucket 513a(1)-513a(n) is to ensure that what is sent into the account is controlled and verified against externally provided metadata.

Following is an exemplary naming convention for the raw bucket path structure: s3://{raw-bucket}/{SEALID}/{Databook-asset-id}/{YYYY}/{MM}Rddl/{HH}/{filename}. This path provides context to which the application is sending data into the bucket via the SEALID and identifies the file via Databook-asset-id. The raw bucket 513a(1)-513a(n) is considered a temporary store. According to exemplary embodiments, the retention of data objects will default to seven days. If the data object is successfully processed by data ingestion automation, then the object may be deleted in advance of the seven-day expiry. The retention of data objects is controlled by the bucket lifecycle configuration. According to exemplary embodiments, the raw bucket 513a(1)-513a(n) is not registered as a data lake location with the central lake formation account (i.e., produced by the lake formation module 514) as consumers do not have access to data in this bucket 513a(1)-513a(n).

The trusted bucket 513b(1)-513b(n), according to exemplary embodiments, is the working location for data producers to access their data, and is where they can source ingested data for processing workflows. Data objects that land in the trusted bucket 513b(1)-513b(n) have met the appropriate governance and controls applied during the ingestion automation process. These data objects are also schematized in a data processing friendly format (e.g., Avro, Parquet). The following an exemplary naming convention for the trusted bucket path structure: s3://{trusted-bucket}/{SEALID}/{Databook-asset-id}/{YYYY}/{MM}/{dd}/{HH}/{filename}. The path follows a similar convention to that of the raw bucket 513a(1)-513a(n). The timestamp in this path is reflective of the time at which the data object originally arrived in the raw bucket 513a(1)-513a(n). Retention in the trusted bucket 513b(1)-513b(n) may be driven by metadata from Databook-asset-id and reflected as tags on the data objects. Bucket lifecycle policies may be configured to automatically enforce retention based on these tags. With this policy, data objects are easily removed or archived to lower Amazon S3 Storage Classes. As with the raw bucket 513a(1)-513a(n), the trusted bucket 513b(1)-513b(n) is not registered as a data lake location with the central lake formation account as consumers do not have access to data in this bucket 513b(1)-513b(n). According to exemplary embodiments, the trusted bucket 513b(1)-513b(n) is the working location for the data producer to perform data transformation operations such as change data capture, lookups, and more. Producers can optionally create AWS Glue Databases and tables for their own processing purposes, but these databases and tables are only accessible locally and are not available for consumption outside of the producer account.

According to exemplary embodiments, the refined bucket 513c(1)-513c(n) is the only bucket within a producer account that is registered with the central lake formation account. This refined bucket 513c(1)-513c(n) is the target for all data underlying databases and tables that the producer has made available through the central data catalog (i.e., produced by the central catalog module 516). The structure of the refined bucket 513c(1)-513c(n) is data product oriented. Having a standardized controlled and consistent structure for all the refined buckets 513c(1)-513c(n) across all producer accounts is critical for enabling automation with the central hub account 506. The following is exemplary naming convention for the refined bucket path structure: s3://{refined-bucket}/{product}/{database}/{table}/partitions/ . . . .

According to exemplary embodiments, the product in the refined bucket naming convention refers to the product within the sub-LOB. For example, within a business banking producer account there are two products: deposits and lending. Within each of these products there could be any number of databases that correspond to data offerings, each comprised of one or many tables. This provides subject area isolation by organizing tables into logical offerings.

According to exemplary embodiments, data retention in the refined bucket 513c(1)-513c(n) is driven by the metadata associated with the data offering in a Databook. The bucket policy lifecycle configuration is used to control the Amazon S3 Storage Class and the removal of data objects in the same way it is configured in the trusted bucket 513c(1)-513c(n).

According to exemplary embodiments, to enable controlled and governed data ingestion, the producer account automatically validates that each dataset is properly registered in the Databook before making it available for processing. This process depends on the schema and incoming file format of each data file being made available in the Databook.

### Ingestion Via SFTP

On-premises, there already exists the Managed File Transfer Service (MFTS) that is being used by applications to move and transfer files throughout the firm and has full support for the use of Secure File Transfer Protocol (SFTP) into the public cloud. With the data mesh architecture 501 of a producer account, the AWS Transfer Family provides a fully managed service to enable file transfer using SFTP into Amazon S3. The MFTS service manages users and grants them permission to a specific home directory on the SFTP server. This home directory gets mapped to a specific prefix on the S3 bucket. In a producer account, this is their S3 raw bucket.

### Ingestion Via Stream

Data ingestion via streaming may be supported in the producer accounts. There are multiple different methods that are available for streaming. According to exemplary embodiments, one method that may be implemented is to enable events to be published from on-premise services to the AWS Kinesis Data Firehose service and allow Firehose to sink the data into the Amazon S3 raw bucket in a producer account. AWS Kinesis Data Firehouse has the capabilities to capture, transform, and deliver streaming data to Amazon S3, Amazon Redshift, and Amazon Elasticsearch Service.

FIG. 6 illustrates an exemplary data ingestion workflow 600 implemented by the CADMM 406 of FIG. 4 in accordance with an exemplary embodiment. As illustrated in FIG. 6, when data files land in the raw bucket 613a, an event is generated on an event bus. The event bus is the mechanism that enables senders and receivers to communicate with each other without knowing about each other (i.e., loosely coupled). The event triggers Databook-asset-id to be parsed from the Amazon S3 path and this is used to call Databook API to retrieve the registration information from the Databook 605 stored onto the corporate data center 603. This registration information is used to accomplish two tasks. First, the schema is retrieved using the Avro data serialization protocol and is registered with the AWS Glue Schema Registry 606. Secondly, the incoming data file parsing information is published as an event to the event bus to be read by the ingestion workflow (S608, S610, S612). The ingestion workflow is an AWS Glue Job that is responsible for moving the received data file out of the raw bucket 613a, schematizing (S608) the data file, running (S610) Technical Data Quality (TDQ) on the data file, and writing (S612) the data file into the trusted bucket 613b. AWS Glue, which is used to author the ingestion workflow, natively supports Amazon Eventbridge Events as triggers and will run in response to events published on the event bus.

According to exemplary embodiments, if there is a failure in the workflow process, a notification is sent to the data product owner with specific information about the cause of the failure. The same notifications are used in reporting service level agreements and to give consumers visibility.

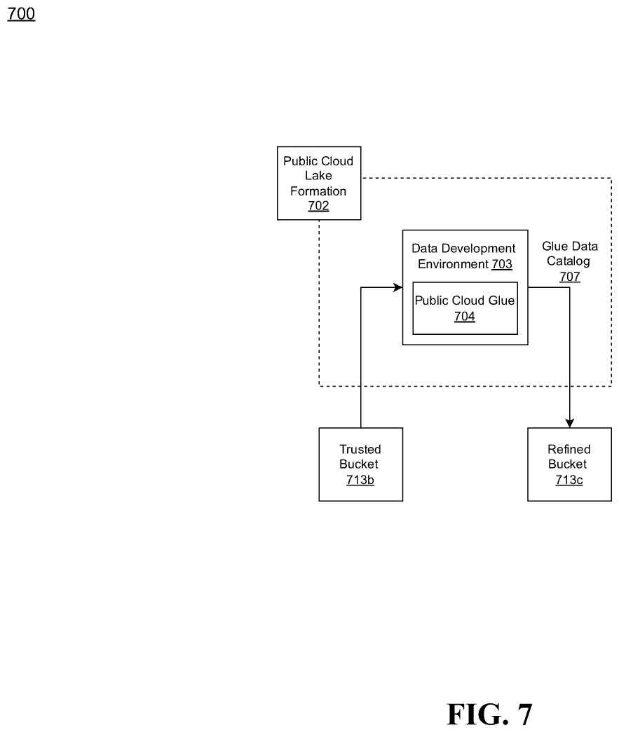

FIG. 7 illustrates an exemplary data processing workflow 700 in the producer account implemented by the CADMM 406 of FIG. 4 in accordance with an exemplary embodiment. As illustrated in FIG. 7, data engineering teams may work to deliver product data sets that are ready for consumption by data consumers. Producers author workflows that generate refined product data sets by creating AWS Glue Jobs (i.e., public cloud glue 704 within the data development environment 703). Glue allows these data engineers to create and automate workflows without needing to manage any infrastructure. Using Glue for interacting with AWS Lake Formation tables (i.e., within public cloud lake formation 702) also provides additional feature benefits. According to exemplary embodiments, one can leverage continuously improving functionality and capabilities from AWS for managing large data lake tables including AWS Governed Tables which supports ACID (Atomicity, Consistency, Isolation, and Durability) transactions, time travel queries to support automated change data capture, as well as cell-level and row-level data security and access controls. Public cloud lake formation 702 is a service that makes it easy to set up a secure data lake in an expedited manner. A data lake is a centralized, curated, and secured repository that stores all your data, both in its original form and prepared for analysis.

According to exemplary embodiments, in the event that data has already been processed on-premises (i.e., outside of the producer account), data is provisioned directly to the trusted bucket 713b. This bypasses the data ingestion automation from the raw bucket (i.e., 613a as illustrated in FIG. 6) to the trusted bucket 713b that is oriented towards continuous data delivery that is performed inside of the producer account. Prior to direct ingestion into the trusted bucket 713b, the delivery mechanism for data transformed on-premises has to have passed its own TDQ process. The ingestion workflow process for delivering data from the trusted bucket 713b to the refined bucket 713c, creating or updating tables, and updating associated metadata in the AWS Glue catalog (i.e., Glue data catalog 707) remains unchanged and should be done inside of the producer account.

According to exemplary embodiments, if an alternative solution is being used by the producer account for data processing and it is intending to move data from the trusted bucket 713b to the refined bucket 713c for consumption, it remains the responsibility of the data producer account to create and update tables in the AWS Glue catalog.

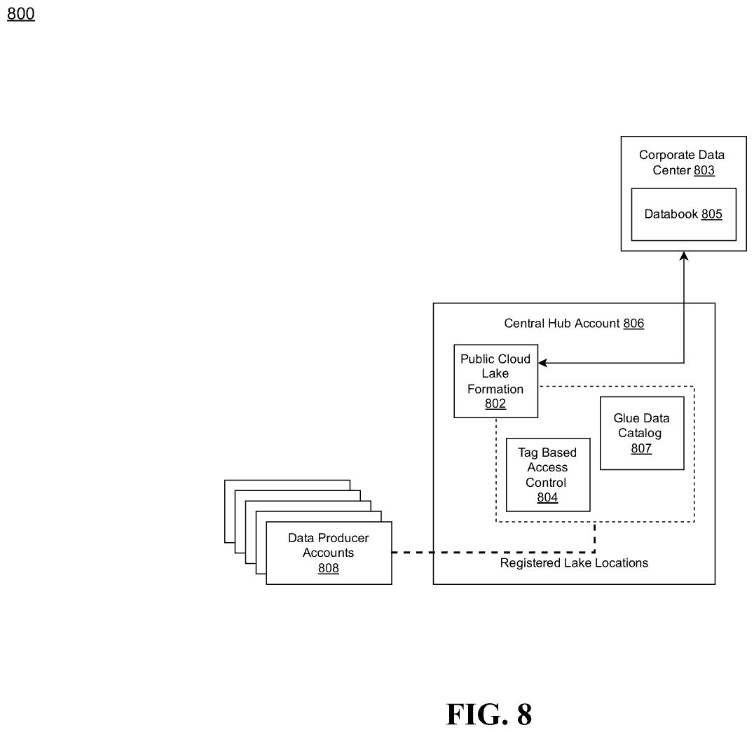

FIG. 8 illustrates an exemplary architecture 800 of a central hub account 806 implemented by the CADMM 406 of FIG. 4 in which the central hub account 806 is a single account to which data producer accounts 808 directly connect in accordance with an exemplary embodiment. According to exemplary embodiments, the operation and administration of the central hub account 806 is a critical component of the data mesh architecture 501 (see FIG. 5) for achieving the goals of a well-functioning data lake.

According to exemplary embodiments, the central hub account 806 is responsible for registering all of the data lake locations from all of the producer accounts 808. A data lake location is the S3 bucket path created by producer accounts 808. When that S3 bucket path is registered, two critical features are enabled: a) the ability to define and control access to all objects under that S3 bucket path is being granted to the central hub account Lake formation (i.e., public cloud lake formation 802); b) the central hub account lake formation is given the ability to retrieve those S3 data objects when resources are accessed through AWS Glue Data Catalog (i.e., Glue data catalog 807). An S3 location underlying an AWS Glue Database should be within a registered data lake location.

According to exemplary embodiments, all data resources shared in the data mesh architecture 501 (see FIG. 5) and all data access is enabled by the central hub account 806 owning the central Glue Data Catalog 807. Data producers expose product data sets to data consumers only through the central Glue Data Catalog 807. It is required that the central hub account 806 owns the central Glue Data Catalog 807 because AWS Lake Formation only allows single step sharing of data catalog resources cross accounts. The central Glue Data Catalog 807 itself is shared numerous times among too many accounts, but each share should originate with the catalog owner.

According to exemplary embodiments, the inability for an account receiving a shared catalog resource to subsequently share that resource with another account is an important part of controlling the data mesh architecture 501. Because the central hub account 806 owns the central Glue Data Catalog 807, all cross account access is controlled and governed through the central hub account 806. This explicitly prevents any data to be shared between data producers and data consumers directly that is not controlled and governed by the central hub account 806.

According to exemplary embodiments, the access control model for governing access to the central Glue Data Catalog 807 is entirely attribute based. Lake Formation natively supports attribute-based access control and has termed it AWS Lake Formation Tag Based Access Control (TBAC) 804 to distinguish it from AWS Identify and Access Management (IAM) attribute-based access control (ABAC) used elsewhere within AWS.

According to exemplary embodiments, a Lake Formation (LF) tag is comprised of a single unique key and up to 15 values, but the disclosure is not limited thereto. The hard limit on the maximum number of allowable values is an important consideration in determining the appropriate tag ontology and structure. There is also a limit on the maximum number of LF-tags per account, 1000, but the disclosure is not limited thereto. Because there is much more freedom in the total number of tags than the number of values in a particular tag, it is more expressive to enumerate tag values as their own tags and use a binary indicator for the value.

According to exemplary embodiments, the LF-tag ontology managed by the central hub account 806 may include three sets of values, but the disclosure is not limited thereto. Each sub-LOB has a unique tag with one allowable value.

{Key:ccb:business-banking, Values:[true]}, . . .

Each sub-LOB product has a unique tag with one allowable value. The relationship to the sub-LOB is captured in the construction of the tag key.

{Key:ccb:business-banking lending, Values:[true]}, . . .

Protection Group Codes (PG-codes) are organized into a single tag with 8 allowable values, but the disclosure is not limited thereto.

{Key:pg-code, Values:[hicnfd, authc, pidirid, intl, govtid, risksc, cnfd, highpi, cnfdpi]}

According to exemplary embodiments, lake formation supports tagging of databases, tables, and columns. The maximum number of tags that can be assigned to a resource is 50, but the disclosure is not limited thereto. By default, lake formation tags on resources cascade from database to table to column unless directly overridden by the assignment of that same tag to a lower-level resource. Each resource only supports a single value to be attached from a tag.

According to exemplary embodiments, Sub-LOB and product tags are attached to databases, and pg-codes are attached to columns

According to exemplary embodiments, the central hub account 806 is responsible for coordinating updates from Databook 805 from the corporate data center 803 and reflecting those changes on a catalog resource. If a change is made, the effect on access control is immediate and may invalidate assumptions about what consumer accounts previously had access to compare with what they have access to now. This has implications on actions taken in a consumer account to purge query results data and send notifications to consumers that a change has been made.

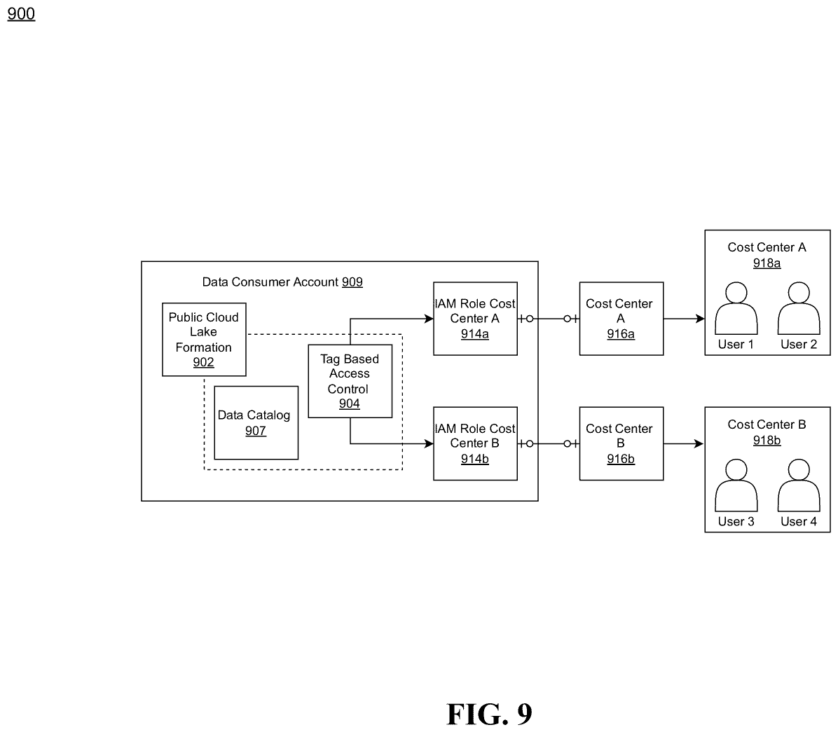

FIG. 9 illustrates an exemplary architecture 900 implemented by the CADMM 406 of FIG. 4 in which IAM roles (i.e., IAM role cost center A 914a, IAM role cost center B 914b) are created and granted public cloud lake formation 902 permissions based on a user's cost center (i.e., cost center A 916a, cost center B 916b) alignment in accordance with an exemplary embodiment.

According to exemplary embodiments, on-premises systems like Teradata and Hive use Role Based Access Control (RBAC) to provide fine grained access control to the data. Users request protection group (PG) based roles to gain access to data. When a user has multiple roles, access is a cumulative sum of all the permissions provided by all the roles.

According to an exemplary embodiment, user permissions within AWS are governed through IAM roles and policies attached to that role. When a user is operating inside of an AWS account (i.e., data consumer account 909), they are identified by the role that they assumed upon signing into that account. If a user has permission to assume multiple roles, they can only assume one role at a time and thus are limited by the policies attached to that specific role. Unlike on-premises implementations, there cannot be a union of permissions across multiple roles for which a user has access.

To mimic the on-premises permission model, there would need to be approximately 3,000 roles created with each having slight variations in access to support approximately 5,000 users across all the consumers. Another option is to create one role per user leading to 5,000 roles.

According to exemplary embodiments, to overcome managing thousands of roles, the CADMM 406 implements a process to group users by cost center and grant permissions to roles aligned to those cost centers. In the exemplary architecture 900, user 1 and user 2 are grouped (i.e., cost center A 918a) based on IAM role cost center A 914a for cost center A 916a. The IAM role cost center A 914a is assigned by the tag based access control 904 by utilizing the data catalog 907 and the public cloud lake formation 902. Similarly, user 3 and user 4 are grouped (i.e., cost center B 918b) based on IAM role cost center B 914b for cost center B 916b. The IAM role cost center B 914b is assigned by the tag based access control 904 by utilizing the data catalog 907 and the public cloud lake formation 902. This model is based on users within a cost center having similar data access requirements to perform their core job functions. According to exemplary embodiments, this model may provide the following benefits: significant reduction in number of roles required; 500-700 roles are created across all consumer accounts 909; reduced administrative burden to create and manage roles; eliminates the need to review and manage individual user permissions; ability for the users within the same cost center to share query results; provides a more collaborative environment with improved end user experience; prevents data mingling by establishing role boundaries, etc., but the disclosure is not limited to.

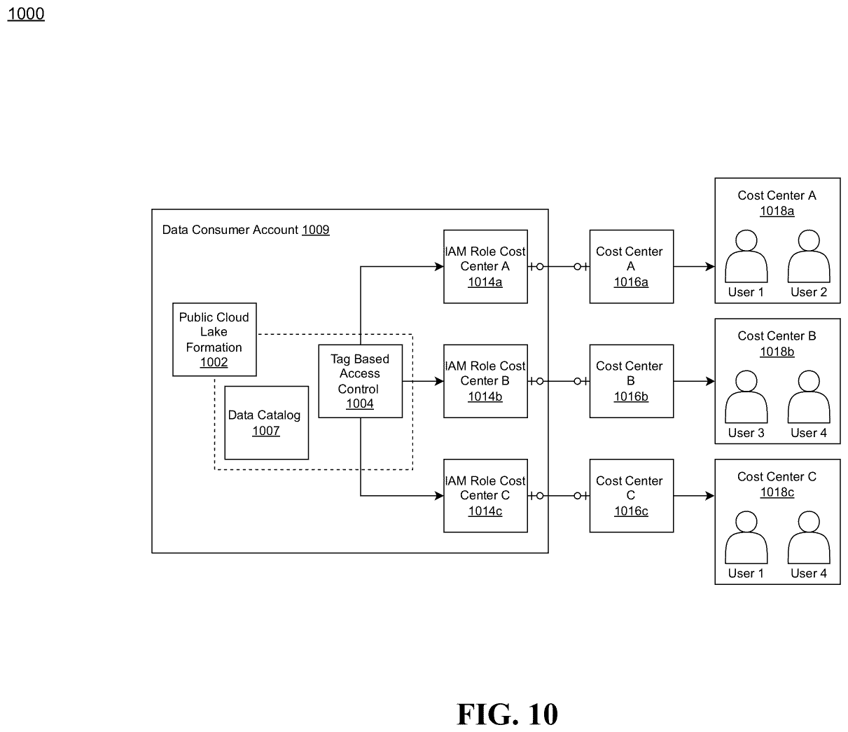

FIG. 10 illustrates another exemplary architecture 1000 implemented by the CADMM 406 of FIG. 4 in which users that have access to multiple roles can only assume one role at a time in accordance with an exemplary embodiment.

For use cases that require users from multiple cost centers to collaborate, new roles can be created that are driven by an approved Data Use Case (DUC) from the Data Use Council. The permissions that are granted to DUC roles are based only on what is approved by the council as part of the DUC itself, and are independent of any permissions that the user may have in their cost center role.

A major distinction between permissions granted to a DUC role and a cost center role is that the permissions granted to a DUC role are time bound. DUC role permissions approved by the Data Use Council require a review on a particular cadence or establishment of hard cut-off time periods on permissions. Both scenarios are fully supported and enforced by revoking the lake formation grants made to the associated IAM role.

In the exemplary architecture 1000 of FIG. 10, user 1 and user 2 are grouped (i.e., cost center A 1018a) based on IAM role cost center A 1014a for cost center A 1016a. The IAM role cost center A 1014a is assigned by the tag based access control 1004 by utilizing the data catalog 1007 and the public cloud lake formation 1002. Similarly, user 3 and user 4 are grouped (i.e., cost center B 1018b) based on IAM role cost center B 1014b for cost center B 1016b. The IAM role cost center B 1014b is assigned by the tag based access control 1004 by utilizing the data catalog 1007 and the public cloud lake formation 1002. Similarly, user 1 and user 4 are grouped (i.e., cost center C 1018c) based on IAM role cost center C 1014c for cost center C 1016c. The IAM role cost center C 1014c is assigned by the tag based access control 1004 by utilizing the data catalog 1007 and the public cloud lake formation 1002. Roles are created across all consumer accounts 1009.

As illustrated in FIG. 10, user 1 and user 4, each of whom have access to their respective cost center role and the DUC role, would only be able to select one of those roles per session. This forces the user to determine which context they will be working in and subsequently must choose the appropriate role.

According to exemplary embodiments, users within a cost center or DUC are by default able to share and see query results from other users assuming the same role. This mimics the behavior of a team space or shared space users have today on-premises. When an IAM role is granted data permissions, it is important that the role does not have a mechanism to subvert the access control being enforced by lake formation. One of the ways in which users typically circumvent this on-premises is by querying data they have access to and then copying their query results to an ungoverned location that additional users can access. To prevent this type of behavior inside of consumer accounts 1009, IAM roles are explicitly prevented from making their query results visible to other roles in the account.

According to exemplary embodiments, exemplary tool for querying data in a consumer account 1009 may be AWS Athena. Athena is a serverless interactive query engine that is natively integrated with the AWS Glue Data Catalog (i.e., data catalog 1004). Athena supports Presto SQL syntax, which includes many powerful operators and functions for aggregation and statistics.

According to exemplary embodiments, users may access Athena in the following ways: in the AWS Console and the Athena query editor; Athena API for submitting and retrieving query results; ODBC (Open Database Connectivity) and JDBC (Java Database Connectivity) connections for querying from on-premises applications.

According to exemplary embodiments, when Athena executes a query, the returned query results are saved to the query results S3 bucket in the consumer account 1009. This S3 location can be configured on a per query basis, but the executing user must have permissions to that S3 location. Users can create tables in their local Glue Data Catalog within Athena by executing a Create Table As (CTAS) command pointing to the query results S3 bucket location.

According to exemplary embodiments, Athena Workgroups is a feature that allows for isolation between multiple Athena users in the same consumer account 1009. For each Athena workgroup, saved queries and the query history is only visible within that specific workgroup. Controls and monitoring are attached to the Athena workgroup. Limits and notifications are set for data scanned per query and total data scanned across each Athena workgroup, allowing for monitoring usage and costs at the workgroup level.

According to exemplary embodiment, another feature of Athena workgroups is the ability to attach default parameters that are included in all queries executed by that workgroup. The most important parameter attached to a workgroup is the S3 query results location that Athena uses when query results are returned. This allows each IAM role to be associated with their own workgroup and segregates query results to the correct location within the analytics bucket automatically.

According to exemplary embodiments, Athena query results are stored in an analytics S3 bucket within the consumer account 1009. The analytics S3 bucket is partitioned such that consumer roles are only able to access the Athena workgroup path in the bucket that aligns to their role. This enforces the segregation previously described in the definition of consumer roles. Within this partition, query results from Athena are always be written to the same location and this location is attached to the settings of each Athena workgroup. s3://{analytics-bucket}/{workgroup-identifier}/athena-query-results/ . . .

One of the challenges with storing query results is that they accumulate over time. To reduce the amount of data that accumulates in the query results S3 bucket, a bucket lifecycle configuration is used to automatically delete data objects from athena-query-results daily. However, this default retention control is bypassed if the data objects underlying a table in the Glue Data Catalog (i.e., data catalog 1007) were created as a result of a CTAS query. These CTAS query data objects are retained for a period of 180 days. If a table is dropped and subsequently recreated by another execution of the CTAS query, the previous underlying data object is only retained for one day and the new data object is retained for 180 days, but the disclosure is not limited to these day limits. Any configurable day limits can be imposed without departing from the scope of the inventive concept as disclosed herein.

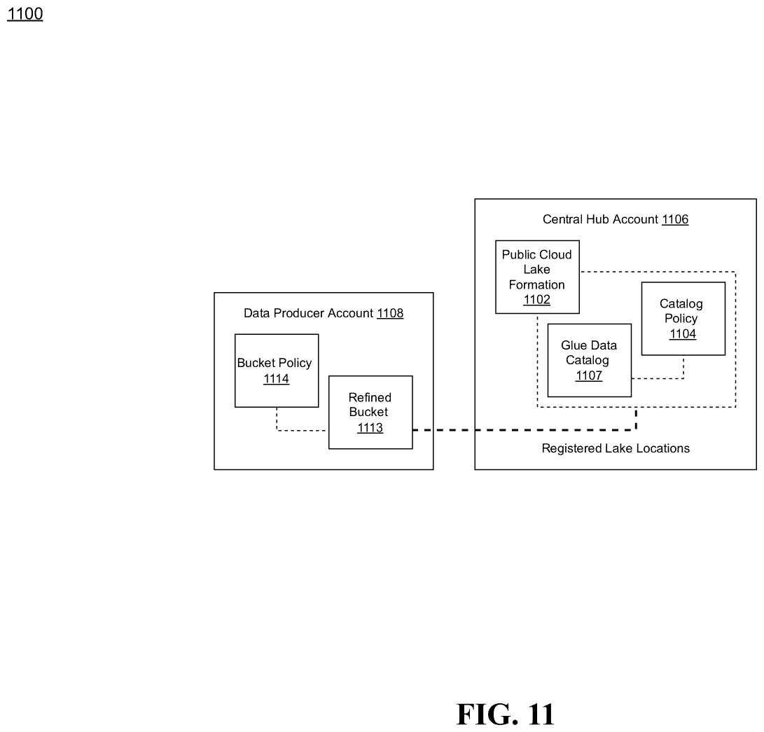

FIG. 11 illustrates another exemplary architecture 1100 implemented by the CADMM 406 of FIG. 4 in which cross account data lake location registration is illustrated in accordance with an exemplary embodiment.

As illustrated in FIG. 11, the central hub account 1106 performs a cross account registration of the refined bucket 1113 from each of the data producer accounts 1108. This is the singular S3 bucket from a producer account 1108 that is registered as a data lake location with the central hub account 1106. The S3 location registered in the central hub account 1106 is at the bucket level. This is important to maintain clarity about which data is governed by lake formation (i.e., public cloud lake formation 1102) and eases management of cross account permissions.

According to exemplary embodiments, when a new data producer account is created, the data lake location is registered by the central hub account 1106. However, if the refined bucket 1113 is not configured to grant cross account access to the lake formation administrator role of the central hub account 1106, the registration of the data lake location has no effect.

According to exemplary embodiments, when a data producer account 1108 or a data consumer account (i.e., 1009 as illustrated in FIG. 10) is added to the data mesh architecture 501 (see FIG. 5), the Central Glue Data Catalog (i.e., Glue Data Catalog 1107) must update the Central Glue Data Catalog resource policy 1104 to enable cross account access. The policy statement indicates that this cross-account catalog access will be administered by lake formation (i.e., public cloud lake formation 1102).

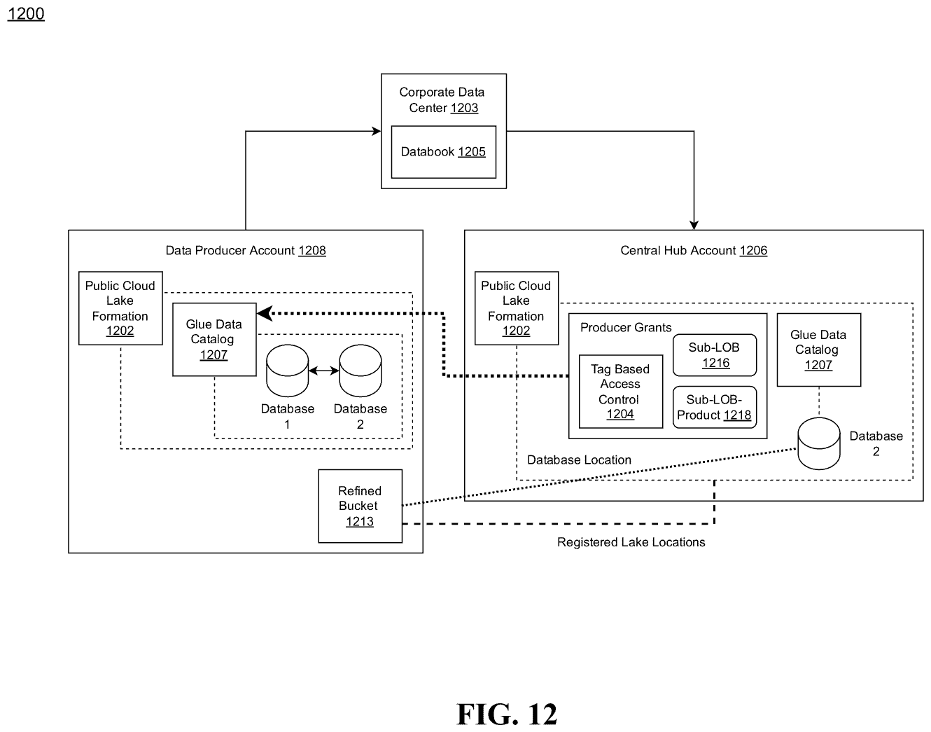

FIG. 12 illustrates an exemplary database requester workflow 1200 between accounts with glue data catalog 1207 tagging implemented by the CADMM 406 of FIG. 4 in accordance with an exemplary embodiment.

According to exemplary embodiments, the associated metadata from Databook 1205 in the corporate data center 1203 may include the sub-LOB, the product, and the name for the database. This is used to infer the S3 location within the requestor's refined bucket 1213 that the database points to as its underlying storage location. Upon creation, the database is tagged in Lake Formation (i.e., public cloud lake formation 1202) with two different tags: a) the requesting sub-LOB 1216 tag (producer); and the product within the sub-LOB 1218 tag (producer). These tags are the two attributes that control the visibility and accessibility of the database back to the requesting producer.

According to exemplary embodiments, within the data producer's account 1208, a resource link to the shared database (i.e., database 2) is created. The resource link is in the producer's Glue Data Catalog (i.e., Glue data catalog 1207) and allows them to reference the shared database (i.e., database 2) as if they owned it. However, any actions against the resource link, including creating and updating tables, are reflected in the shared database (i.e., database 2) owned by the central hub account 1206. In this exemplary embodiment, database 1 is not shared between the data producer account 1208 and the central hub account 1206.

According to exemplary embodiments, when a producer account 1208 creates tables and columns within a database, the central hub account 1206 reacts to this event and determines what the appropriate tags are for the table and columns. The central hub account does this by using the identifier of the data offering from the database resource tag to call Databook 1205 and retrieve the table and column level attributes such as protection group codes for consumer access control. Upon retrieving the attributes, the central hub account 1206 applies the associated Lake Formation Tags to the newly created columns in the Central Glue Data Catalog (i.e., Glue Data Catalog 1207).

According to exemplary embodiments, the default behavior for any member who is part of a specific sub-LOB consumer account cannot query the table and columns without getting access to all required tags.

According to exemplary embodiments, an LF-tag (Lake Formation tag) grant controls who can describe tags, who can associate tags to resources, and who can grant those same permissions to other roles or accounts. The central hub account 1206 controls the visibility of these tags to other accounts. In absence of these explicit LF-tag grants, external accounts are not able to see the LF-tags owned by the Central Glue Data Catalog (i.e., glue data catalog 1207).

According to exemplary embodiments, glue data catalog 1207 grants enable controlling access to data catalog resources by assigning tag expressions to roles in an account or to other accounts. Grants are made up of tag expressions, which provide a powerful mechanism for condition-based access. Within a single tag expression, multiple tag criteria are included, and the entire expression must resolve as true to enable access. However, multiple grants can be made to the same principal and each tag expression associated with that grant is evaluated independently. In this scenario, only one of the tag expressions needs to be evaluated as true to enable access.

According to exemplary embodiments, data producer account 1208 oriented grants are used to control a producer's access and permissions on databases that it has requested, owns, and operates. There are two tags used in the grant to a producer account 1208 which are: the sub-LOB tag associated with that account, and the products within that sub-LOB that the producer account owns. These two grants made to the data producer account 1208 enables the Data Lake Administrator in that account to assign all required permissions to roles that are creating and updating tables. In addition, any database that is requested and created after the policy is in effect and has the appropriate tags immediately becomes visible to the producer.

According to exemplary embodiments, within each data producer account 1208 the Data Lake Administrator is responsible for granting permissions to roles in the data producer account 1208. When a grant is being made to a role, the same tags owned by the central hub account 1206 are used in the tag expression that were used to share the resource to the account. Because there is a resource link in the local Glue Data Catalog (i.e., Glue Data Catalog 1207) in addition to the shared database (i.e., database 2), permission to that resource link also needs to be enabled. According to exemplary embodiments, the following methods may be implemented for ensuring complete permissions are enabled. In the first method, the Data Lake Administrator ensures that the tags on the resource linked database mirror the tags on the shared database. This method requires that only one grant be used to enable access to both databases. In the second method, the Data Lake Administrator creates their own tags and attach those to the resource linked database. Then a second grant is issued that gives the role access to the resource linked database by including the locally owned tags in the tag expression.

According to exemplary embodiments, consumer oriented grants are used to give consumer accounts visibility to databases, tables, and columns from the Central Glue Data Catalog. The same two tags used to make grants to producers (i.e., sub-LOBs and products) are used to grant databases to consumers. There is also an inclusion of PG-code, which controls access to columns.

According to exemplary embodiments, within each data consumer account the Data Lake Administrator is responsible for granting permissions to roles in the consumer account. When a grant is being made to a role the same tags owned by the central hub account are used in the tag expression that was used to share the resource to the account. The resource grants made to consumer roles only need to be granted to the resource link created in the consumer account data catalog unlike the grant-on-target in a producer account because the consumer roles are not given alter permissions on databases or tables.

According to exemplary embodiments, the grants made to consumer account roles are based on the sub-LOB and PG-code combination for which a specific role has been approved.

According to exemplary embodiments, when a data producer account is created, the raw, trusted, and refined S3 buckets are created, and the refined bucket location is registered with the lake formation central hub account. Producers use MFTS to ingest data from on-premises to their raw S3 bucket which generates an event in the data mesh architecture. An automated process moves the data from raw S3 bucket to the trusted S3 bucket post the technical data quality checks. The trusted S3 bucket is the area where producers access the data. AWS Glue Jobs are used to do required transformations and then write the data to product aligned database paths in the refined S3 bucket. Producers can request new database creations with the central hub account. The Central Data Lake Formation Administrator creates a database, maps it with producer/product tags and grant permissions to the data producer account. This enables the data producer account to create resource links pointing to the shared database. The producer refers to the resource links whenever the database is referenced during Glue Crawler table creation.

According to exemplary embodiments, tag based access controls are used within the data mesh architecture to grant access. With both the products residing in the same producer account, there is no permission that needs to be granted through the central hub account. The Data Lake Formation Administrator in the data producer account grants permissions to the required role within the data producer account.

According to exemplary embodiments, in the case of a data producer account needing access to product data that is in another data producer account the following processes may be implemented for them to have access: the data producer account requesting access to this data submits a request to the central hub account for a grant to a product in another account; the central hub account makes a grant to the requesting producer with only select permissions on the other producers sub-LOB and product tags; producers cannot control access to their own data and they cannot enable cross account access directly to another producer, but the disclosure is not limited thereto.

According to exemplary embodiments, if a product is moving to a new data producer account (i.e., different sub-LOB), the following processes may be implemented: a data offering update is initiated in Databook; databases associated to that product are additionally tagged with the new sub-LOB; the producer copies data from the existing S3 location to the new one; the central hub account updates the Central Glue Data Catalog database to point to the new S3 location in the new producer sub-LOB's account; the previous sub-LOB tag is removed from the database; the central hub account notifies Databook that the data offering update is complete, but the disclosure is not limited thereto.

According to exemplary embodiments, assuming the producer has already made a request for a database and created tables in that database, the only action a producer needs to ensure is that the database is registered in Databook as a data offering. According to exemplary embodiments, each column has a PG-code assigned. Without PG-codes, columns may not be tagged with PG-code in the central hub account and may not be visible to consumers. Only consumers that have been granted permissions matching the tags of the sub-LOB and PG-codes will be able to access the data.

According to exemplary embodiments, producers can reclassify columns in Databook triggering the following sequence of events: the central hub account will remove the existing PG-code from the column, making it inaccessible; data consumer accounts are notified of the change that is occurring to an existing column; the central hub account applies the new PG-code to the column, but the disclosure is not limited thereto.

According to exemplary embodiments, users from multiple cost centers can collaborate on a project by having their use case approved by the DUC. Once approved, a DUC role is created that the users can assume while signing into AWS. Users that are permitted to access the approved DUC role will be able to share query results amongst themselves.

According to exemplary embodiments, by default, all cost centers have access that is pre-approved by the governance team. If users need more access to the cost center, they can submit a request to the governance team to elevate the default access approved to the respective cost center.

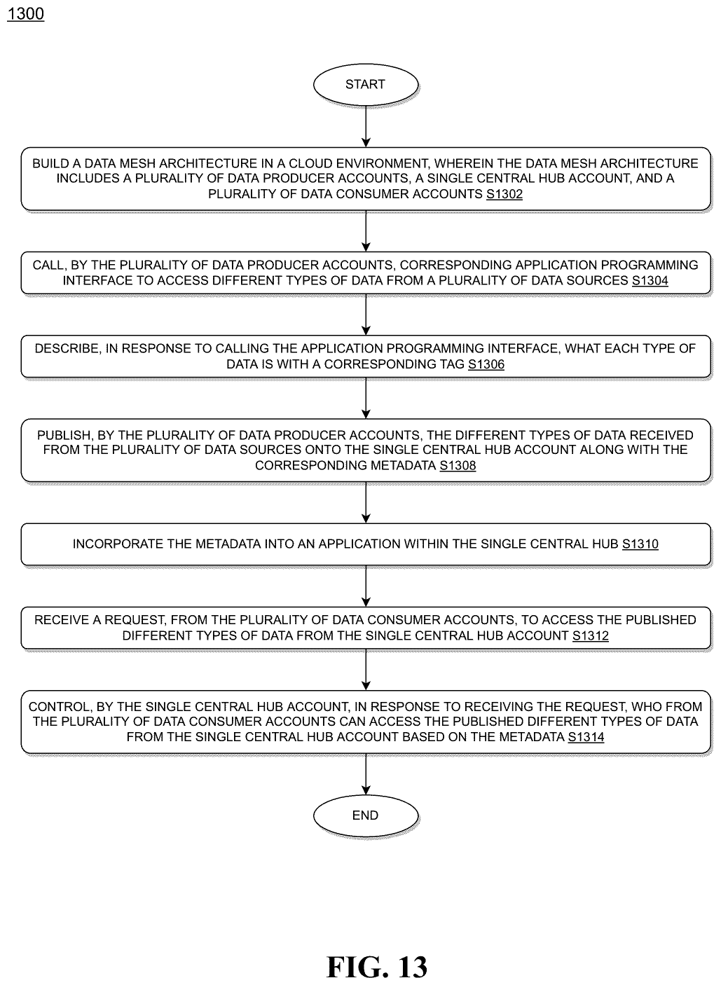

FIG. 13 illustrates an exemplary flow chart 1300 implemented by the CADMM 406 of FIG. 4 for scalable implementation and automatic centralized seamless data access to data consumers/analyst and applications in accordance with an exemplary embodiment. It may be appreciated that the illustrated process 1300 and associated steps may be performed in a different order, with illustrated steps omitted, with additional steps added, or with a combination of reordered, combined, omitted, or additional steps.

As illustrated in FIG. 13, at step S1302, the process 1300 may include building a data mesh architecture in a cloud environment, wherein the data mesh architecture includes a plurality of data producer accounts, a single central hub account, and a plurality of data consumer accounts.

At step S1304, the process 1300 may include calling, by the plurality of data producer accounts, corresponding application programming interface to access different types of data from a plurality of data sources.

At step S1306, the process 1300 may include describing, in response to calling the application programming interface, what each type of data is with a corresponding tag, wherein each tag is a metadata associated with each type of data describing what that data is.

At step S1308, the process 1300 may include publishing, by the plurality of data producer accounts, the different types of data received from the plurality of data sources onto the single central hub account along with the corresponding metadata.

At step S1310, the process 1300 may include incorporating the metadata into an application within the single central hub.

At step S1312, the process 1300 may include receiving a request, from the plurality of data consumer accounts, to access the published different types of data from the single central hub account.

At step S1314, the process 1300 may include controlling, by the single central hub account, in response to receiving the request, who from the plurality of data consumer accounts can access the published different types of data from the single central hub account based on the metadata.

According to exemplary embodiments, in the process 1300, each data producer account of the plurality of data producer accounts may be configured to manage procurement, transformation, and presentation of data and delegate responsibility for controlling access to their data to the single central hub account.

According to exemplary embodiments, in the process 1300, the single central hub account may be configured to connect the plurality of data producer accounts and the plurality of data consumer accounts in a manner such that the data consumer accounts can only access data of the data producer accounts via the single central hub account.

According to exemplary embodiments, in the process 1300, each data consumer account among the plurality of data consumer accounts may be configured to enable analytic environments in which end users can access data exposed by the data producer accounts through the single central hub account.

According to exemplary embodiments, the process 1300 may further include: implementing the data mesh architecture in a manner such that data is not duplicated outside of the data producer accounts.

According to exemplary embodiments, in the process 1300, in the data mesh architecture, each type of data may be treated and enabled as data product and the plurality of data sources are product owners of corresponding data product in the data mesh architecture.

According to exemplary embodiments, in the process 1300, the different types of data may include data received from system of records that owns system of record data products; data received from utility data sources that won utility data products; data received from product data sets; and data received from third party data sets, but the disclosure is not limited thereto.

According to exemplary embodiments, the CADMD 402 may include a memory (e.g., a memory 106 as illustrated in FIG. 1) which may be a non-transitory computer readable medium that may be configured to store instructions for implementing a CADMM 406 for automatically providing centralized seamless data access to data consumers/analyst and application as disclosed herein. The CADMD 402 may also include a medium reader (e.g., a medium reader 112 as illustrated in FIG. 1) which may be configured to read any one or more sets of instructions, e.g., software, from any of the memories described herein. The instructions, when executed by a processor embedded within the CADMM 406, 506 or within the CADMD 402, may be used to perform one or more of the methods and processes as described herein. In a particular embodiment, the instructions may reside completely, or at least partially, within the memory 106, the medium reader 112, and/or the processor 104 (see FIG. 1) during execution by the CADMD 402.

According to exemplary embodiments, the instructions, when executed, may cause a processor embedded within the CADMM 406 or the CADMD 402 to perform the following: building a data mesh architecture in a cloud environment, wherein the data mesh architecture includes a plurality of data producer accounts, a single central hub account, and a plurality of data consumer accounts; calling, by the plurality of data producer accounts, corresponding application programming interface to access different types of data from a plurality of data sources; describing, in response to calling the application programming interface, what each type of data is with a corresponding tag, wherein each tag is a metadata associated with each type of data describing what that data is; publishing, by the plurality of data producer accounts, the different types of data received from the plurality of data sources onto the single central hub account along with the corresponding metadata; incorporating the metadata into an application within the single central hub account; receiving a request, from the plurality of data consumer accounts, to access the published different types of data from the single central hub account; and controlling, by the single central hub account, in response to receiving the request, who from the plurality of data consumer accounts can access the published different types of data from the single central hub account based on the metadata. According to exemplary embodiments, the processor may be the same or similar to the processor 104 as illustrated in FIG. 1 or the processor embedded within CADMD 202, CADMD 302, CADMD 402, and CADMM 406.

According to exemplary embodiments corresponding to the non-transitory computer readable medium (i.e., memory 106), each data producer account of the plurality of data producer accounts may be configured to manage procurement, transformation, and presentation of data and delegate responsibility for controlling access to their data to the single central hub account.

According to exemplary embodiments corresponding to the non-transitory computer readable medium (i.e., memory 106), the single central hub account may be configured to connect the plurality of data producer accounts and the plurality of data consumer accounts in a manner such that the data consumer accounts can only access data of the data producer accounts via the single central hub account.

According to exemplary embodiments corresponding to the non-transitory computer readable medium (i.e., memory 106), each data consumer account among the plurality of data consumer accounts may be configured to enable analytic environments in which end users can access data exposed by the data producer accounts through the single central hub account.

According to exemplary embodiments corresponding to the non-transitory computer readable medium (i.e., memory 106), the instructions, when executed, may further cause the processor 104 to perform the following: implementing the data mesh architecture in a manner such that data is not duplicated outside of the data producer accounts.

According to exemplary embodiments corresponding to the non-transitory computer readable medium (i.e., memory 106), in the data mesh architecture, each type of data may be treated and enabled as data product and the plurality of data sources are product owners of corresponding data product in the data mesh architecture.

According to exemplary embodiments corresponding to the non-transitory computer readable medium (i.e., memory 106), the different types of data may include data received from non-transitory computer readable medium of records that owns non-transitory computer readable medium of record data products; data received from utility data sources that won utility data products; data received from product data sets; and data received from third party data sets, but the disclosure is not limited thereto.

According to exemplary embodiments as disclosed above in FIGS. 1-13, technical improvements effected by the instant disclosure may include a platform for implementing a cloud agnostic data mesh module for providing scalable implementation and automated centralized seamless data access to data consumers/analyst and application, but the disclosure is not limited thereto. For example, according to exemplary embodiments as disclosed above in FIGS. 1-13, technical improvements effected by the instant disclosure may include a platform for implementing a cloud agnostic data mesh module to establish a data mesh in a public cloud that enables accelerated access to trusted and secure business value product data sets that are aligned to high priority strategic use cases from consumers; leverage the design of a data mesh in the public cloud enabling data to be free from the duplication and processing complexities that currently bind and constrain its use in today's systems, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing centralized seamless data access by utilizing one or more processors along with allocated memory, the method comprising:
building a data mesh architecture in a cloud environment, wherein the data mesh architecture includes a plurality of data producer accounts, a single central hub account, and a plurality of data consumer accounts;
calling, by the plurality of data producer accounts, corresponding application programming interface to access different types of data from a plurality of data sources;
describing, in response to calling the application programming interface, what each type of data is with a corresponding tag, wherein each tag is a metadata associated with each type of data describing what that data is;
publishing, by the plurality of data producer accounts, the different types of data received from the plurality of data sources onto the single central hub account along with the corresponding metadata;
incorporating the metadata into an application within the single central hub account;
receiving a request, from the plurality of data consumer accounts, to access the published different types of data from the single central hub account; and
controlling, by the single central hub account, in response to receiving the request, who from the plurality of data consumer accounts can access the published different types of data from the single central hub account based on the metadata.

2. The method according to claim 1, wherein each data producer account of the plurality of data producer accounts is configured to manage procurement, transformation, and presentation of data and delegate responsibility for controlling access to their data to the single central hub account.

3. The method according to claim 1, wherein the single central hub account is configured to connect the plurality of data producer accounts and the plurality of data consumer accounts in a manner such that the data consumer accounts can only access data of the data producer accounts via the single central hub account.

4. The method according to claim 1, wherein each data consumer account among the plurality of data consumer accounts is configured to enable analytic environments in which end users can access data exposed by the data producer accounts through the single central hub account.

5. The method according to claim 1, further comprising:
implementing the data mesh architecture in a manner such that data is not duplicated outside of the data producer accounts.

6. The method according to claim 1, wherein in the data mesh architecture, each type of data is treated and enabled as data product and the plurality of data sources are product owners of corresponding data product in the data mesh architecture.

7. The method according to claim 6, wherein the different types of data include data received from system of records that owns system of record data products, data received from utility data sources that won utility data products; data received from product data sets; and data received from third party data sets.

8. A system for providing centralized seamless data access, the system comprising:
a processor; and
a memory operatively connected to the processor via a communication interface, the memory storing computer readable instructions, when executed, causes the processor to:
build a data mesh architecture in a cloud environment, wherein the data mesh architecture includes a plurality of data producer accounts, a single central hub account, and a plurality of data consumer accounts;
call, by the plurality of data producer accounts, corresponding application programming interface to access different types of data from a plurality of data sources;
describe, by the plurality of data producer accounts, in response to calling the application programming interface, what each type of data is with a corresponding tag, wherein each tag is a metadata associated with each type of data describing what that data is;
publish, by the plurality of data producer accounts, the different types of data received from the plurality of data sources onto the single central hub account along with the corresponding metadata;
incorporate the metadata into an application within the single central hub account;
receive a request, from the plurality of data consumer accounts, to access the published different types of data from the single central hub account; and
control, by the single central hub account, in response to receiving the request, who from the plurality of data consumer accounts can access the published different types of data from the single central hub account based on the metadata.

9. The system according to claim 8, wherein each data producer account of the plurality of data producer accounts is configured to manage procurement, transformation, and presentation of data and delegate responsibility for controlling access to their data to the single central hub account.

10. The system according to claim 8, wherein the single central hub account is configured to connect the plurality of data producer accounts and the plurality of data consumer accounts in a manner such that the data consumer accounts can only access data of the data producer accounts via the single central hub account.

11. The system according to claim 8, wherein each data consumer account among the plurality of data consumer accounts is configured to enable analytic environments in which end users can access data exposed by the data producer accounts through the single central hub account.

12. The system according to claim 8, wherein the processor is further configured to:
implement the data mesh architecture in a manner such that data is not duplicated outside of the data producer accounts.

13. The system according to claim 8, wherein in the data mesh architecture, each type of data is treated and enabled as data product and the plurality of data sources are product owners of corresponding data product in the data mesh architecture.

14. The system according to claim 13, wherein the different types of data include data received from system of records that owns system of record data products, data received from utility data sources that won utility data products; data received from product data sets; and data received from third party data sets.

15. A non-transitory computer readable medium configured to store instructions for providing centralized seamless data access, wherein, when executed, the instructions cause a processor to perform the following:
building a data mesh architecture in a cloud environment, wherein the data mesh architecture includes a plurality of data producer accounts, a single central hub account, and a plurality of data consumer accounts;
calling, by the plurality of data producer accounts, corresponding application programming interface to access different types of data from a plurality of data sources;
describing, in response to calling the application programming interface, what each type of data is with a corresponding tag, wherein each tag is a metadata associated with each type of data describing what that data is;
publishing, by the plurality of data producer accounts, the different types of data received from the plurality of data sources onto the single central hub account along with the corresponding metadata;
incorporating the metadata into an application within the single central hub account;
receiving a request, from the plurality of data consumer accounts, to access the published different types of data from the single central hub account; and
controlling, by the single central hub account, in response to receiving the request, who from the plurality of data consumer accounts can access the published different types of data from the single central hub account based on the metadata.

16. The non-transitory computer readable medium according to claim 15, wherein each data producer account of the plurality of data producer accounts is configured to manage procurement, transformation, and presentation of data and delegate responsibility for controlling access to their data to the single central hub account.

17. The non-transitory computer readable medium according to claim 15, wherein the single central hub account is configured to connect the plurality of data producer accounts and the plurality of data consumer accounts in a manner such that the data consumer accounts can only access data of the data producer accounts via the single central hub account.

18. The non-transitory computer readable medium according to claim 15, wherein each data consumer account among the plurality of data consumer accounts is configured to enable analytic environments in which end users can access data exposed by the data producer accounts through the single central hub account.

19. The non-transitory computer readable medium according to claim 15, wherein the instructions, when executed, further cause the processor to perform the following:
implementing the data mesh architecture in a manner such that data is not duplicated outside of the data producer accounts.

20. The non-transitory computer readable medium according to claim 15, wherein in the data mesh architecture, each type of data is treated and enabled as data product and the plurality of data sources are product owners of corresponding data product in the data mesh architecture, and
wherein the different types of data include data received from system of records that owns system of record data products, data received from utility data sources that won utility data products; data received from product data sets; and data received from third party data sets.
